(19) United States
(12) Patent Application Publication
(10) Pub. No.: US 2006/0061235 A1
(43) Pub. Date: Mar. 23, 2006

(54) Ultrasonic motor and method for operating the same

(75) Inventor: Tomoki Funakubo, Tokyo (JP)

Correspondence Address: Thomas Spinelli;Scully, Scott, Murphy & Presser, 400 Garden City Plaza, Garden City, NY, 11530, US

(73) Assignee: Olympus Corporation, Tokyo (JP)

(21) Appl. No.: 11/222,600

(22) Filed: Sep. 9, 2005

(30) Foreign Application Priority Data
Sep. 22, 2004 (JP) 2004-274405

(51) Int. Cl. H02N 2/00

(52) U.S. Cl. 310/323.16

(57) ABSTRACT

An ultrasonic motor capable of simultaneously generating a plurality of vibration modes efficiently generates each vibration mode so as to stably obtain high motor power. The ultrasonic motor an ultrasonic vibrator and a pressing unit. The ultrasonic vibrator includes an electromechanical converting element that generates a substantially elliptic vibration at an output end of the ultrasonic vibrator by simultaneously generating two different vibration modes by applying a first alternating-current voltage of a first phase and a second alternating-current voltage of a second phase to the electromechanical converting elements, wherein the first and second alternating-current voltages have a predetermined phase difference and predetermined driving frequencies. The pressing unit is configured to press the output end of the ultrasonic vibrator against a driven body. The output end of the ultrasonic vibrator is pressed against the driven body by a pressing force that causes mechanical resonant frequencies in the two different vibration modes to substantially match each other.

### BACKGROUND OF THE INVENTION

1. Field of the Invention

This invention relates to an ultrasonic motor and a method for operating the same.

2. Description of Related Art

Recently, ultrasonic motors have been drawing attention as a new type of motor replacing electromagnetic motors. Ultrasonic motors have the following advantages over known electromagnetic motors:

1) Ultrasonic motors are capable of high torque without using gears;

2) Ultrasonic motors have holding force when powered off;

3) Ultrasonic motors have high resolution;

4) Ultrasonic motors are quiet; and

5) Ultrasonic motors do not generate magnetic noise and are unaffected by noise.

A known ultrasonic motor is described in Japanese Unexamined Patent Application Publication No. 9-224385. The ultrasonic motor disclosed in this publication is configured so that an ultrasonic vibrator is pressed against a driven body by a pressure spring with a predetermined pressing force. In the known ultrasonic motor according to this publication, the pressing force is set at a value smaller than the pressing force at which a longitudinal-vibration resonant frequency and a flexural-vibration resonant frequency match each other, and the driving frequency is set at a value between the longitudinal-vibration resonant frequency and the flexural-vibration resonant frequency. Under such conditions, the ultrasonic vibrator is excited so as to generate longitudinal vibrations and flexural vibrations, causing the driven body to be driven leftward or rightward.

However, since the longitudinal-vibration resonant frequency and the flexural-vibration resonant frequency of a known ultrasonic motor, such as the one disclosed in Japanese Unexamined Patent Application Publication No. 9-224385, do not match each other because the pressing force of the ultrasonic motor is set at a value smaller than that at which the longitudinal-vibration resonant frequency and the flexural-vibration resonant frequency match each other, the maximum vibration amplitudes of the longitudinal and flexural vibration modes cannot be used. Thus, the ultrasonic motor cannot achieve a sufficient motor output. Moreover, since the driving frequency is set to a value between the longitudinal-vibration resonant frequency and the flexural-vibration resonant frequency, the maximum vibration amplitudes of the longitudinal and flexural vibration modes cannot be used. Thus, in this case too, the ultrasonic motor cannot achieve a sufficient motor output.

### BRIEF SUMMARY OF THE INVENTION

The present invention has been conceived in light of the above-described problems, and an object thereof is to provide an ultrasonic motor and operating method thereof in which it is possible to simultaneously generate a plurality of vibration modes and to efficiently generate each vibration mode to stably obtain high motor power.

In order to achieve the objects described above, the present invention provides the following solutions.

An ultrasonic motor according to a first aspect of the present invention includes an ultrasonic vibrator and a pressing unit. The ultrasonic vibrator includes an electromechanical converting element that generates a substantially elliptic vibration at an output end of the ultrasonic vibrator by simultaneously generating two different vibration modes by applying a first alternating-current voltage of a first phase and a second alternating-current voltage of a second phase to the electromechanical converting element, wherein the first and second alternating-current voltages have a predetermined phase difference and predetermined driving frequencies. The pressing unit presses the output end of the ultrasonic vibrator against a driven body. The pressing force against the driven body on the output end of the ultrasonic vibrator by the pressing unit is set to a value which allows the mechanical resonant frequencies of the two different vibration modes to substantially match each other. In other words, the output end of the ultrasonic vibrator is pressed against the driven body by a pressing force that causes mechanical resonant frequencies in the two different vibration modes to substantially match each other.

In the ultrasonic motor according to the first aspect of the present invention, by applying the alternating-current voltages having a predetermined phase difference and predetermined driving frequencies to the electromechanical converting element of the ultrasonic vibrator, two different vibration modes are generated simultaneously and a substantially elliptic vibration is generated at the output end of the ultrasonic vibrator. By pressing the output end against the driven body by the movement of the pressing unit, the frictional force generated between the output end and the driven body causes the driven body to be driven in a tangential direction of the substantially elliptic motion of the output end.

In this case, the pressing force applied by the pressing unit is adjusted so that the mechanical resonant frequencies of the two different modes substantially match each other. Thus, it is possible to simultaneously use substantially the maximum vibration amplitudes of the two vibration modes when driving the driven body. As a result, high motor power can be obtained and the driven body can be driven efficiently.

In the ultrasonic motor according to the first aspect of the present invention, the pressing force may be set to a value substantially in the center of a predetermined range corresponding to a range of pressing forces that cause the mechanical resonant frequencies in the two different vibration modes to substantially match each other.

In this way, even when the value of the pressing force changes slightly for some reason, the ultrasonic motor can be operated with a pressing force within the range in which the mechanical resonant frequencies of the two different modes match each other. Thus, substantially the maximum vibration amplitudes of the two difference vibration modes can be stably utilized.

In the ultrasonic motor according to the first aspect of the present invention, the driving frequencies may be higher than the mechanical resonant frequencies in the two different vibration modes.

In this way, the ultrasonic vibrator can be driven in a range where the change in the vibration velocity is relatively gentle with respect to the change in the driving frequency. Thus, the ultrasonic motor can be stably controlled.

In the ultrasonic motor according to the first aspect of the present invention, the vibration direction of one of the two vibration modes at the output end of the ultrasonic vibrator may be the same as the pressing direction of the pressing unit, and the vibration direction of the other vibration mode at the output end of the ultrasonic vibrator may be a direction substantially orthogonal to the pressing direction.

As the pressing force of the pressing unit increases, the mechanical resonant frequencies of the two different vibration modes change. In the vibration mode in which the vibration direction is the same as the pressing direction of the pressing unit, the change in the mechanical resonant frequencies with respect to the change in the pressing force is great, whereas, in the vibration mode in which the vibration direction is substantially orthogonal to the pressing direction, the change in the mechanical resonant frequencies with respect to the change in the pressing force is relatively small. Accordingly, by using the difference in the changes of the mechanical resonant frequencies in the two different vibration modes with respect to the pressing force, the mechanical resonant frequencies in the two different vibration modes can be easily matched with each other by changing the pressing force generated by the operation of the pressing unit.

In the ultrasonic motor according to the first aspect of the present invention, the two different vibration modes may be a flexural vibration mode and a longitudinal vibration mode.

By using a flexural vibration mode and a longitudinal vibration mode as the vibration modes, the output end of the ultrasonic vibrator can be vibrated in two directions orthogonal to each other so as to easily generate a substantially elliptic vibration. The mechanical resonant frequencies in the two different vibration modes can be matched with each other by the operation of the pressing unit so as to drive the ultrasonic motor with substantially the maximum amplitudes of the two orthogonal vibrations. Thus, high motor power can be obtained.

In the ultrasonic motor according to the first aspect of the present invention, the driven body may be moved linearly.

In this way, an ultrasonic linear motor having a high motor power can be provided.

In the ultrasonic motor according to the first aspect of the present invention, the driven body may be moved rotatively.

In this way, an ultrasonic rotary motor having a high motor power can be provided.

A method according to a second aspect of the present invention method for operating an ultrasonic motor having an ultrasonic vibrator includes the step of setting a pressing force against the driven body on the output end of the ultrasonic vibrator to a value which allows the mechanical resonant frequencies of the two different vibration modes to substantially match each other. The ultrasonic vibrator includes an electromechanical converting element that generates a substantially elliptic vibration at an output end of the ultrasonic vibrator by simultaneously generating two different vibration modes by applying a first alternating-current voltage of a first phase and a second alternating-current voltage of a second phase to the electromechanical converting elements, wherein the first and second alternating-current voltages have a predetermined phase difference and predetermined driving frequencies.

In the method according to the second aspect of the present invention, by applying the alternating-current voltages having a predetermined phase difference and predetermined driving frequencies to the electromechanical converting element of the ultrasonic vibrator, two different vibration modes are generated simultaneously and a substantially elliptic vibration is generated at the output end of the ultrasonic vibrator. By pressing the output end of the ultrasonic vibrator against the driven body by the movement of the pressing unit, the frictional force generated between the output end and the driven body causes the driven body to be driven in a tangential direction of the substantially elliptic motion of the output end.

In this case, by adjusting the pressing force, the mechanical resonant frequencies of the two different modes can be substantially matched with each other. Thus, it is possible to simultaneously use substantially the maximum vibration amplitudes of the two vibration modes when driving the driven body. As a result, high motor power can be obtained and the driven body can be driven efficiently.

In the method according to the second aspect of the present invention, the pressing force may be set to a value substantially in the center of a predetermined range. The predetermined range corresponds to a range of pressing forces that cause the mechanical resonant frequencies in the two different vibration modes to substantially match each other.

In this way, even when the value of the pressing force changes slightly for some reason, the ultrasonic motor can be operated with a pressing force within the range in which the mechanical resonant frequencies of the two different modes match each other. Thus, the substantially maximum vibration amplitudes of the two different vibration modes can be stably utilized.

In the method according to the second aspect of the present invention, the driving frequencies may be higher than the mechanical resonant frequencies in the two different vibration modes.

In this way, the ultrasonic vibrator can be driven in a range where the change in the vibration velocity is relatively gentle with respect to the change in the driving frequency. Thus, the ultrasonic motor can be stably controlled.

According to aspects of the present invention described above, since the ultrasonic vibrator can be driven with the mechanical resonant frequencies in the two different vibration modes substantially matching each other, substantially the maximum vibration amplitudes of the two different vibration modes can be used simultaneously. In this way, a high motor power can be obtained and the driven body can be efficiently driven.

### BRIEF DESCRIPTION OF THE SEVERAL VIEWS OF THE DRAWINGS

FIG. 1 illustrates the overall structure of an ultrasonic motor according to a first embodiment of the present invention;

FIG. 2 is a perspective view of an ultrasonic vibrator of the ultrasonic motor illustrated in FIG. 1;

FIG. 3 is a perspective view of a piezoelectric layered member constituting the ultrasonic vibrator illustrated in FIG. 2;

FIG. 4A is a perspective view of a piezoelectric ceramic sheet constituting the piezoelectric layered member illustrated in FIG. 3;

FIG. 4B is a perspective view of another piezoelectric ceramic sheet constituting the piezoelectric layered member illustrated in FIG. 3;

FIG. 5 illustrates the piezoelectric layered member shown in FIG. 2 when vibrating in a first-order longitudinal vibration mode based on a computer analysis;

FIG. 6 illustrates the piezoelectric layered member shown in FIG. 2 vibrating in a second-order flexural vibration mode based on a computer analysis;

FIG. 7A is a graph illustrating the change in frequency characteristics of the vibration velocity of the ultrasonic vibrator illustrated in FIG. 2 in response to a predetermined pressing force;

FIG. 7B is a graph illustrating the change in frequency characteristics of the vibration velocity of the ultrasonic vibrator illustrated in FIG. 2 in response to a predetermined pressing force;

FIG. 7C is a graph illustrating the change in frequency characteristics of the vibration velocity of the ultrasonic vibrator illustrated in FIG. 2 in response to a predetermined pressing force;

FIG. 8 is a graph illustrating how the mechanical vibration frequencies in different vibration modes of the ultrasonic vibrator illustrated in FIG. 2 depend on the pressing force;

FIG. 9 illustrates the overall structure of an ultrasonic motor according to a second embodiment of the present invention;

FIG. 10 is a perspective view of an ultrasonic vibrator of the ultrasonic motor illustrated in FIG. 9; and

FIG. 11 is a graph illustrating how the mechanical vibration frequencies in different vibration modes of the ultrasonic vibrator illustrated in FIG. 9 depend on the pressing force.

### DETAILED DESCRIPTION OF THE INVENTION

### First Embodiment

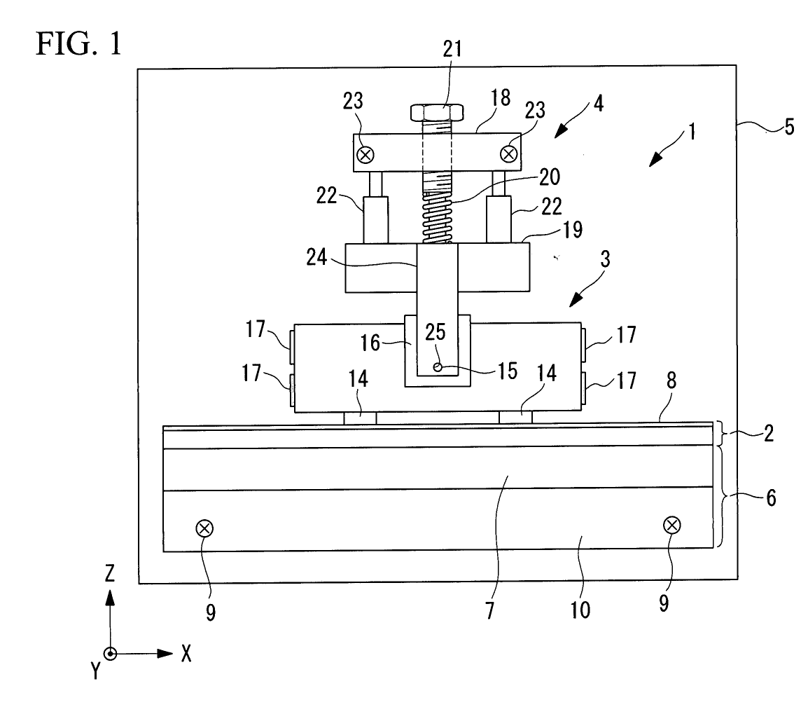

Now, an ultrasonic motor according to a first embodiment of the present invention will be described below with reference to FIGS. 1 to 8.

An ultrasonic motor 1 according to this embodiment, as illustrated in FIG. 1, includes a driven body 2, an ultrasonic vibrator 3 disposed in contact with the driven body 2, and a pressing unit 4 for pressing the ultrasonic vibrator 3 against the driven body 2. The driven body 2 is fixed to a movable member 7 of a linear bearing 6, which is fixed to a base 5. A sliding plate 8 made of, for example, zirconia ceramic is bonded to the driven body 2 on the surface contacting the ultrasonic vibrator 3. Screws 9 fix a fixed member 10 of the linear bearing 6 to the base 5.

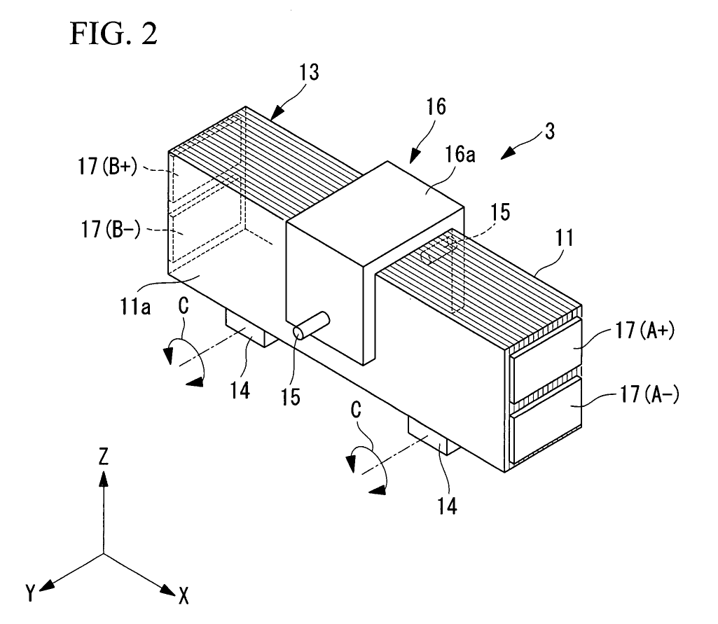

The ultrasonic vibrator 3, as illustrated in FIGS. 2 to 4B, includes a rectangular piezoelectric layered member 13, two friction-contact members 14 (output ends) bonded on a side surface of the piezoelectric layered member 13, and a vibrator holding member 16 having pins 15 protruding from the sides adjacent to the side surface having the friction-contact members 14. The piezoelectric layered member 13 is made up of a stack of rectangular piezoelectric ceramic sheets 11. On one side of each of the piezoelectric ceramic sheets 11, sheets of inner electrodes 12 are provided (refer to FIGS. 4A and 4B).

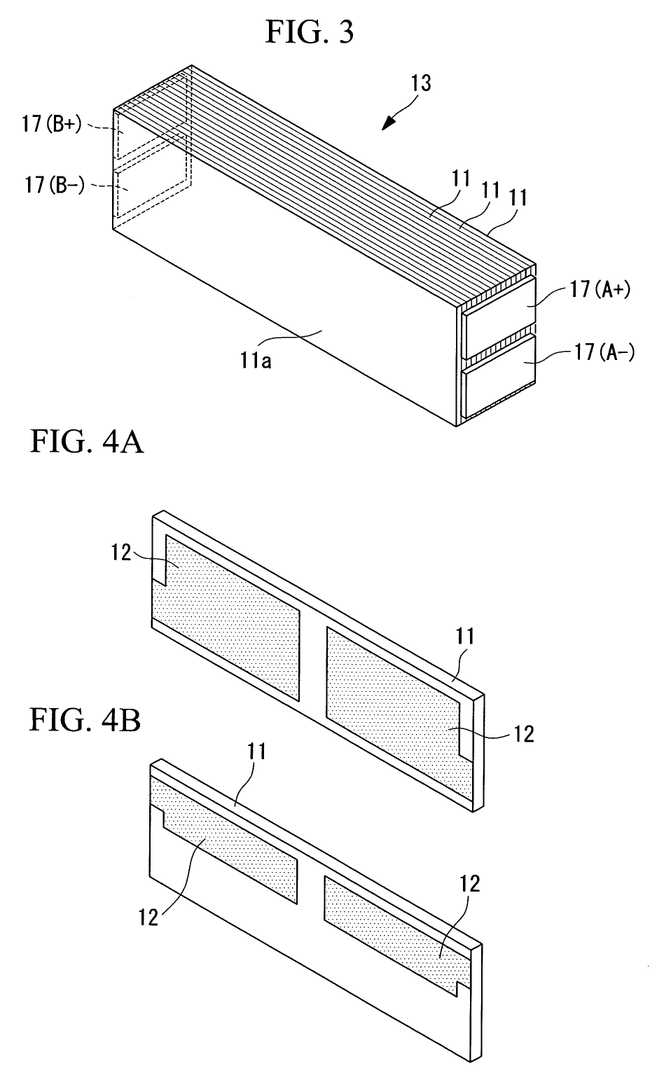

The piezoelectric layered member 13, as illustrated in FIG. 3, for example, has a length of 18 mm, a width of 4.4mm, and a thickness of 2 mm.

The piezoelectric ceramic sheets 11 constituting the piezoelectric layered member 13, as illustrated in FIGS. 4A and 4B, for example, are lead zirconium titanate (hereinafter referred to as ‘PZT’) based piezoelectric ceramic elements having a thickness of about 80 μm. For the PZT, a hard-type PZT having a large Qm value is selected. The Qm value is about 1,800.

The inner electrodes 12, for example, are composed of silver-palladium alloy and have a thickness of about 4 μm. A piezoelectric ceramic sheet 11a, which is the outermost layer of the stack of the piezoelectric ceramic sheets 11, is not provided with the inner electrodes 12. The piezoelectric ceramic sheets 11, except for the piezoelectric ceramic sheet 11a, each include a pair of inner electrodes 12 of one of the two different types. The two different types of inner electrodes 12 are illustrated in FIGS. 4A and 4B.

The type of piezoelectric ceramic sheet 11 illustrated in FIG. 4A has the inner electrodes 12 disposed on most of the surface. Two inner electrodes 12 are disposed adjacent to each other in the longitudinal direction with an insulating distance of about 0.4 mm. The inner electrodes 12 are disposed about 0.4 mm from the edges, while a portion of the piezoelectric ceramic sheet 11 extends to the edge.

The type of piezoelectric ceramic sheet 11 illustrated in FIG. 4B has the inner electrodes 12 disposed in an area corresponding to substantially half of the width of the piezoelectric ceramic sheet 11. Two inner electrodes 12 are disposed adjacent to each other in the longitudinal direction with an insulating distance of about 0.4 mm. The inner electrodes 12 are disposed about 0.4 mm from the edge, while a portion of the piezoelectric ceramic sheet 11 extends to the edge.

The two different types of piezoelectric ceramic sheets 11 provided with the different-shaped inner electrodes 12 (i.e., the piezoelectric ceramic sheet 11 illustrated in FIGS. 4A provided with a large inner electrode 12 and the piezoelectric ceramic sheet 11 illustrated in FIGS. 4B provided with a small inner electrode 12) are alternately stacked so as to form the rectangular piezoelectric layered member 13.

Four external electrodes 17 are disposed on the piezoelectric layered member 13, one pair of external electrodes 17 being disposed on each longitudinal end of the piezoelectric layered member 13. The external electrodes 17 are each connected to a group of inner electrodes 12 provided at the same position on the same type of piezoelectric ceramic sheets 11. In this way, the inner electrodes 12 provided at the same position on the same type of piezoelectric ceramic sheets 11 have the same electric potential. The external electrodes 17 have electrical connections not shown in the drawings. The electrical connections may be established by any type of flexible wiring material, such as lead wires or flexible substrates.

The piezoelectric layered member 13 is manufactured, for example, as described below.

To manufacture the piezoelectric layered member 13, first, the piezoelectric ceramic sheets 11 are prepared. The piezoelectric ceramic sheets 11 are prepared, for example, by casting a slurry mixture of a calcinated powder of PZT and a predetermined binder onto a film using a doctor blade method, drying the mixture, and removing the dried mixture from the film.

The material for the inner electrodes 12 is printed on each of the prepared piezoelectric ceramic sheets 11 using a mask having a pattern for the inner electrode 12. First, the piezoelectric ceramic sheet 11la with no inner electrode 12 is provided. Then, the two types of piezoelectric ceramic sheets 11 having different-shaped inner electrodes 12 are carefully aligned and alternately stacked on the piezoelectric ceramic sheet 11a with the inner electrodes 12 facing downward towards the piezoelectric ceramic sheet 11a. The stacked piezoelectric ceramic sheets 11 are bonded by thermocompression, cut into a predetermined shape, and fired at a temperature of about 1,200° C. In this way, the piezoelectric layered member 13 is manufactured.

Subsequently, silver is plated onto the inner electrodes 12 exposed at the edge of the piezoelectric ceramic sheets 11 such that the inner electrodes 12 are joined together to form the external electrodes 17.

Finally, a high-voltage direct current is applied between the opposing inner electrodes 12 to polarize and piezoelectrically activate the piezoelectric ceramic sheets 11.

Now, the operation of the piezoelectric layered member 13, manufactured by the above-described process, will be described.

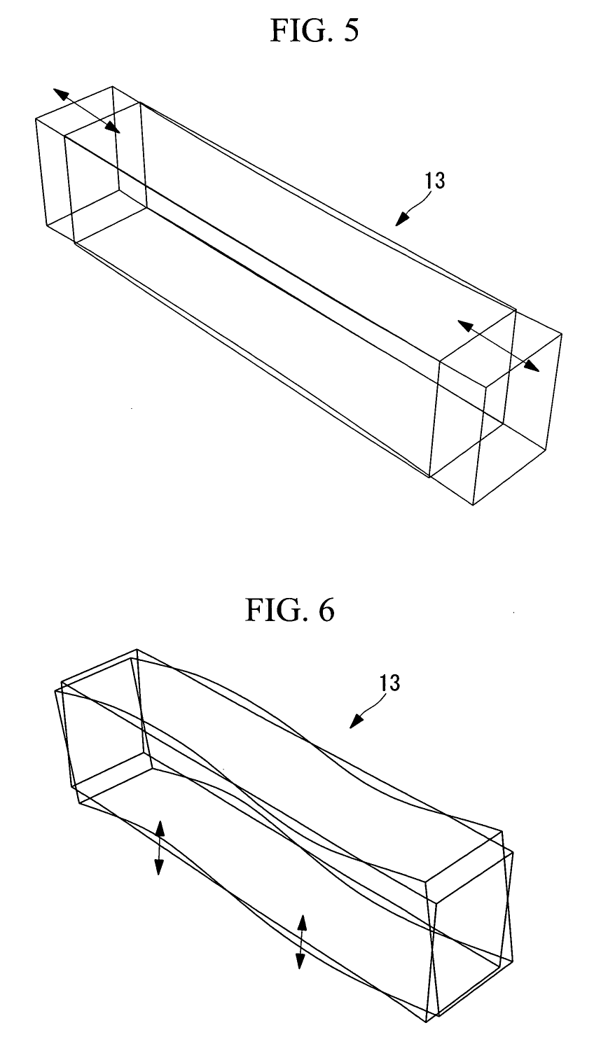

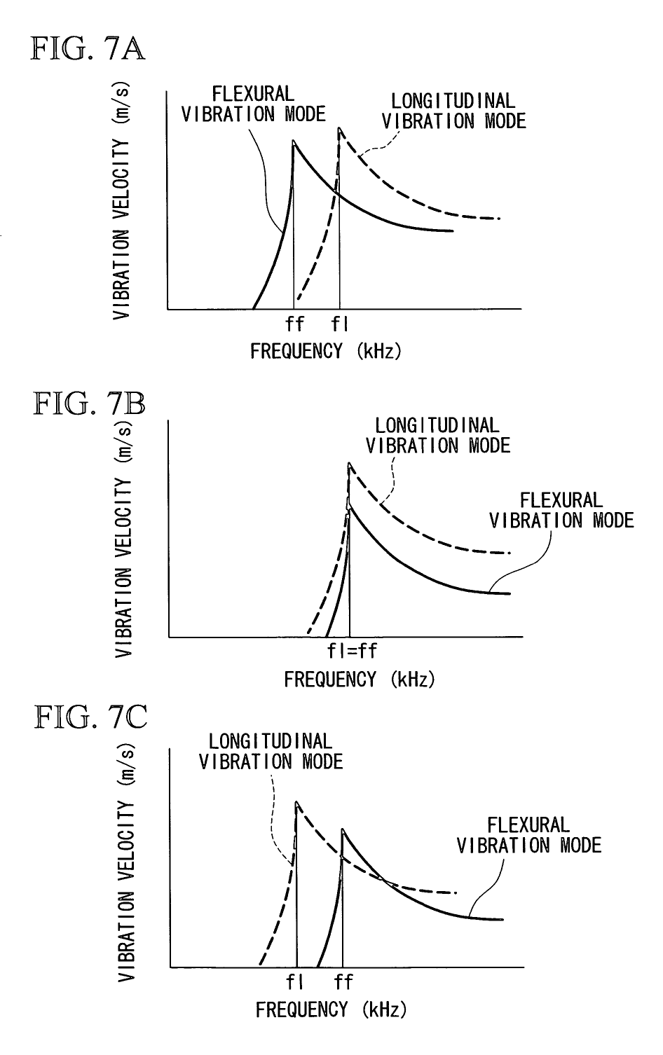

The two external electrodes 17 that are provided on a first longitudinal end of the piezoelectric layered member 13 are defined as A-phase (A+and A−) external electrodes 17, and the two external electrodes 17 that are provided on a second longitudinal end of the piezoelectric layered member 13 correspond to B-phase (B+and B−) external electrodes 17. By applying alternating-current voltages corresponding to resonant frequencies and having synchronous phases to the A-phase and B-phase external electrodes 17, the piezoelectric layered member 13 is excited and a first-order longitudinal vibration is generated, as illustrated in FIG. 5. By applying alternating-current voltages corresponding to resonant frequencies and having opposite phases to the A-phase and B-phase external electrodes 17, the piezoelectric layered member 13 is excited and a second-order flexural vibration is generated, as illustrated in FIG. 6. FIGS. 5 and 6 illustrate the results of a computer analysis based on a finite element method.

The two friction-contact members 14 are bonded on the piezoelectric layered member 13 at positions corresponding to the loops of the second-order flexural vibration. In this way, the friction-contact members 14 are displaced in the longitudinal direction of the piezoelectric layered member 13 (i.e., X direction in FIG. 2) when a first-order longitudinal vibration is generated and are displaced in the width direction of the piezoelectric layered member 13 (i.e., Z direction in FIG. 2) when a second-order flexural vibration is generated.

Consequently, by applying the alternating-current voltages corresponding to the resonant frequencies that have a phase difference of 90° to the A-phase and B-phase external electrodes 17 of the ultrasonic vibrator 3, the first-order longitudinal vibration and the second-order flexural vibration are generated simultaneously. As a result, a vibration in a substantially elliptic motion in a clockwise or counterclockwise direction is generated at the friction-contact members 14, as indicated by arrows C in FIG. 2.

The vibrator holding member 16 includes a substantially U-shaped holding member 16a, and the pins 15, which are integrated with the holding member 16a and protrude orthogonally from both side surfaces of the holding member 16a. The holding member 16a is bonded to the piezoelectric layered member 13 with, for example, silicone resin or epoxy resin, in such a manner that the piezoelectric layered member 13 is clamped in the width direction. With the holding member 16a bonded to the piezoelectric layered member 13, the pins 15 are disposed coaxially on both sides of the holding member 16a at a position on the piezoelectric layered member 13 corresponding to a common node of the longitudinal vibration and the flexural vibration.

The pressing unit 4, as illustrated in FIG. 1, includes a bracket 18, a pressing member 19, a coil spring 20, an adjustment screw 21, and guiding bushes 22. The bracket 18 is fixed on the base 5 with screws 23 at a position a predetermined distance away from the ultrasonic vibrator 3 in the width direction (Z direction) on the opposite side of the ultrasonic vibrator 3 from the friction-contact members 14. The pressing member 19 is supported so that it is movable in the width direction of the ultrasonic vibrator 3 with respect to the bracket 18. The coil spring 20 applies a pressing force to the pressing member 19, and the adjustment screw 21 adjusts the pressing force. The guiding bushes 22 guide the movement of the pressing member 19 with respect to the bracket 18.

The pressing member 19 includes two support plates 24 sandwiching the ultrasonic vibrator 3 in the thickness direction thereof. The support plates 24 have through-holes 25 for passing through the pins 15 of the vibrator holding member 16. The pressing force applied to the pressing member 19 is transmitted to the ultrasonic vibrator 3 through the support plates 24 and the pins 15 passed through the through-holes 25.

The coil spring 20 is a compression coil spring interposed between the adjustment screw 21 and the pressing member 19. By changing the fastening position of the adjustment screw 21 with respect to the bracket 18, the amount of elastic deformation of the coil spring 20 is changed so as to change the pressing force applied to the pressing member 19 in a direction toward the ultrasonic vibrator 3.

In the ultrasonic motor 1 according to this embodiment, the adjustment screw 21 is adjusted as described below.

FIGS. 7A to 7C illustrate the measurement results of the vibration velocity in the vicinity of the ultrasonic vibrator 3 measured by a three-dimensional Doppler vibration meter when the phase difference of the voltages applied to the A-phase and B-phase external electrodes 17 of the ultrasonic vibrator 3 is 90° or −90°. FIG. 7A illustrates the resonance characteristics when the adjustment screw 21 is completely loosened and a pressing force is not applied to the pressing member 19. FIGS. 7B and 7C illustrate the resonance characteristics when the adjustment screw 21 is at different fastening positions. The pressing force applied by the adjustment screw 21 is greater in FIG. 7C than in FIG. 7B.

As illustrated in FIG. 7A, when a pressing force is not applied, the maximum mechanical vibration frequency fl in the longitudinal vibration mode is greater than the maximum mechanical vibration frequency ff in the flexural vibration mode. As illustrated in FIG. 7B, as the pressing force is gradually increased, the maximum mechanical vibration frequencies fl and ff gradually become closer and eventually match each other. As illustrated in FIG. 7C, by continuing to increase the pressing force, the magnitudes of the maximum mechanical vibration frequencies will be reversed so that the maximum mechanical vibration frequency fl becomes smaller than the maximum mechanical vibration frequency ff.

In the ultrasonic motor 1 according to this embodiment, the adjustment screw 21 is adjusted so that the maximum mechanical vibration frequency fl and the maximum mechanical vibration frequency ff match each other, as illustrated in FIG. 7B.

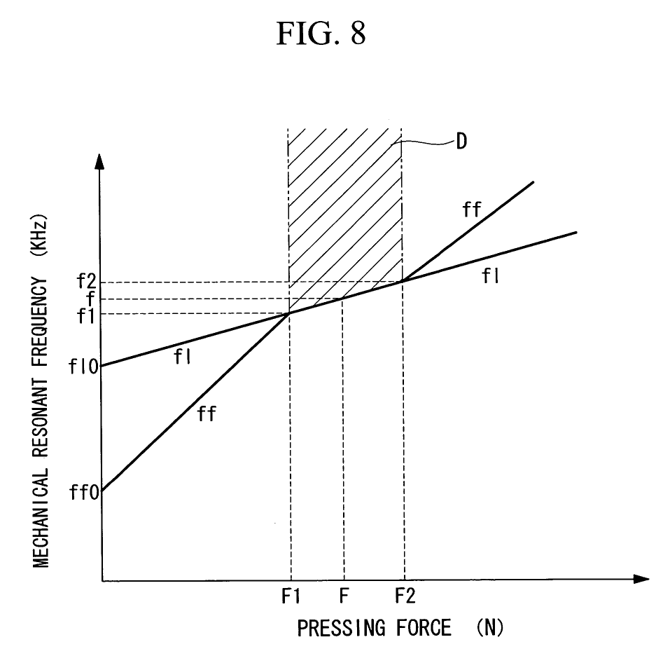

FIG. 8 is a graph illustrating how the mechanical vibration frequencies fl and ff in the different vibration modes depend on the pressing force.

As illustrated in FIG. 8, in the ultrasonic motor 1 according to this embodiment, when a pressing force is not applied to the pressing unit 4, the mechanical resonant frequency fl0 in the longitudinal vibration mode is higher than the mechanical resonant frequency ff0 in the flexural vibration mode. As a concrete example, the mechanical resonant frequency fl0 of the longitudinal vibration mode may be 89.0 khz and the mechanical resonant frequency ff0 of the flexural vibration mode may be 86.2 khz. By gradually increasing the pressing force, the maximum mechanical vibration frequencies fl and ff gradually become closer and eventually match each other at a pressing force F1. Here, for example, the pressing force F1 is 800 gf (7.85 N) and the mechanical resonant frequency f1 corresponding to the pressing force F1, as illustrated in FIG. 8, is 89.6 khz.

By continuing to increase the pressing force, the maximum mechanical vibration frequencies fl and ff continue to match each other until a pressing force F2. When the pressing force is greater than the pressing force F2, the mechanical resonant frequency of the flexural vibration mode ff becomes higher than the mechanical resonant frequency of the longitudinal vibration mode fl. Here, for example, the pressure F2 is 1.4 kgf (13.7 N) and the mechanical resonant frequency f2 corresponding to the pressing force, F2 as illustrated in FIG. 8, is 90.8 khz.

In the ultrasonic motor 1 according to this embodiment, the adjustment screw 21 is adjusted so that the pressing force falls between the pressing forces F1 and F2 at which the mechanical resonant frequency fl in the longitudinal vibration mode and the mechanical resonant frequency ff in the flexural vibration mode match each other. It is more desirable to adjust the adjustment screw 21 so that the pressing force is half of the sum of the pressing forces F1 and F2 (F=(F1+F2)/2).

Now, the operation of the ultrasonic motor 1 according to this embodiment, having the above-described structure, will be described below.

To operate the ultrasonic motor 1 according to this embodiment, high-frequency voltages (A-phase and B-phase) having a phase difference of 90° are supplied to the A-phase and B-phase external electrodes 17 via the wires connected to the external electrodes 17.

In this way, a substantially elliptic vibration, which is the outcome of combining the longitudinal vibration mode and the flexural vibration mode, is generated at the friction-contact members 14 bonded to the ultrasonic vibrator 3. The driven body 2 is driven by the frictional force generated between the driven body 2 and the sliding plate 8 in the tangential direction of the elliptic motion.

In the ultrasonic motor 1 according to this embodiment, having the above-described structure, the pressing force is set between the pressing forces F1 and F2 so that the mechanical resonant frequency fl in the longitudinal vibration mode and the mechanical resonant frequency ff in the flexural vibration mode, which are simultaneously generated in the ultrasonic vibrator 3, match each other. In this way, the maximum vibration amplitude in each vibration mode can be used to drive the driven body 2 and obtain large output force.

By adjusting the adjustment screw 21 so that pressing force is F=(F1+F2)/2, where the mechanical vibration frequencies fl and ff match each other, the pressing force F can be maintained so that the mechanical vibration frequencies fl and ff match each other even when the actual value of the pressure F changes for some reason. Consequently, a stable large output force can be obtained.

When the ultrasonic motor 1 is driven with the mechanical vibration frequencies fl and ff matching each other in such a manner as described above, it is desirable that the frequencies of the high-frequency voltages applied to the A-phase and B-phase external electrodes 17 be in the high-frequency range (region D in FIG. 8) where frequencies are higher than the mechanical resonant frequencies. More specifically, as illustrated in FIGS. 7A to 7C, the vibration characteristics of the ultrasonic motor 1 differ in the low-frequency region and the high-frequency region, separated by the mechanical resonant frequencies fl and ff. In the low-frequency region, where the frequency is lower than the mechanical resonant frequencies fl and ff, the vibration velocity changes rapidly in response to a change in frequency, whereas, in the high-frequency region, where the frequency is higher than the mechanical resonant frequencies fl and ff, the vibration velocity changes slowly in response to a change in frequency. For this reason, by driving the ultrasonic motor 1 at a frequency in the high-frequency region, where the frequency is higher than the mechanical resonant frequencies fl and ff, stable vibration velocity is maintained even when the frequency changes.

### Second Embodiment

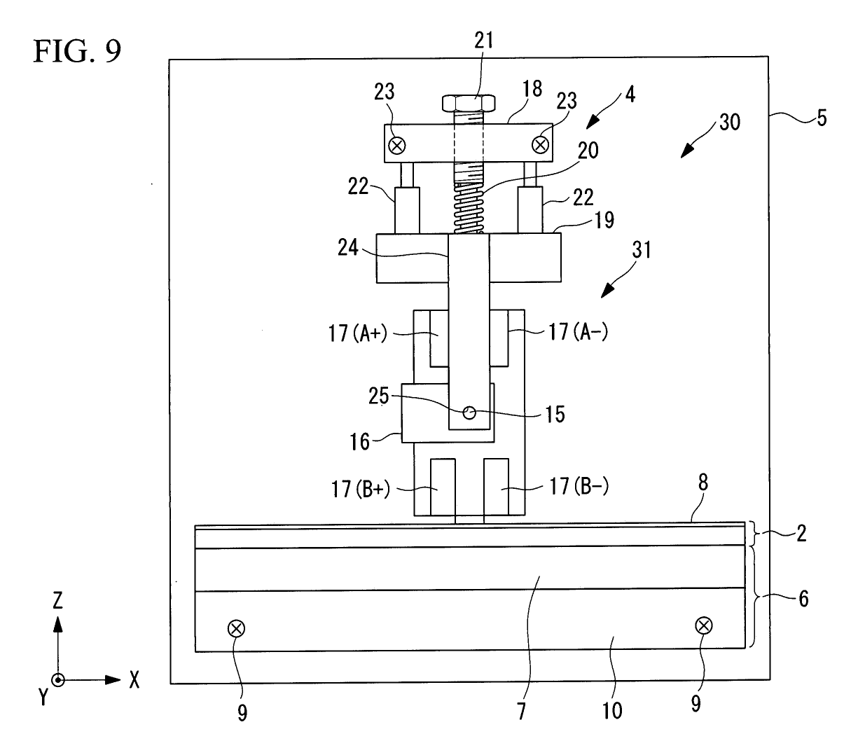

Now, an ultrasonic motor 30 according to a second embodiment of the present invention will be described with reference to FIGS. 9 to 11.

In the description below, components that are the same as those in the ultrasonic motor 1 according to the first embodiment are represented by the same reference numerals and their descriptions are omitted.

The ultrasonic motor 30 according to this embodiment differs from the ultrasonic motor 1 according to the first embodiment in that an ultrasonic vibrator 31 facing a different direction compared to the ultrasonic vibrator 3 according to the first embodiment is disposed in contact with a driven body 2, as illustrated in FIG. 9.

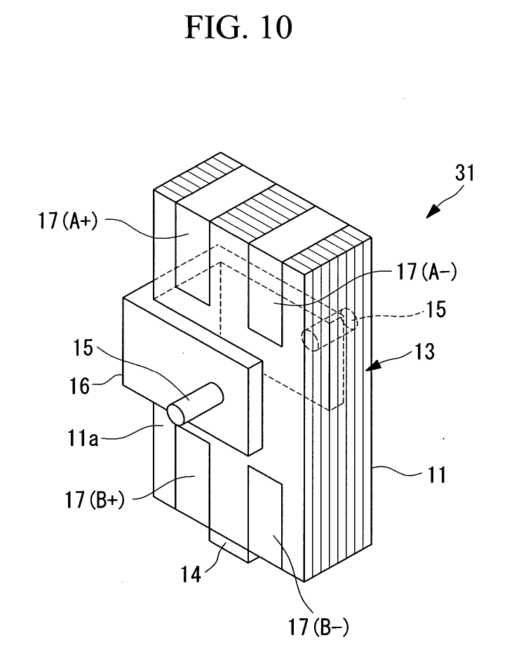

The ultrasonic vibrator 31 according to this embodiment, as illustrated in FIG. 10, includes a piezoelectric layered member 13 similar to that according to the first embodiment. However, the ultrasonic vibrator 31 differs from the ultrasonic vibrator 3 according to the first embodiment in that a friction-contact member 14 is provided only on one of the longitudinal ends of the piezoelectric layered member 13. External electrodes 17 connected to inner electrodes 12 of the piezoelectric layered member 13 extend to the side surfaces (i.e., outermost surfaces in the thickness direction) of the piezoelectric layered member 13 so that there is enough wiring space for the external electrodes 17 even when the longitudinal end surface of the piezoelectric layered member 13 is disposed close to the driven body 2.

In the ultrasonic vibrators 31 having the above-described structure, two external electrodes 17 extending from a first end of the piezoelectric layered member 13 in the longitudinal direction are defined as the A-phase (A+ and A−) external electrodes 17, and two external electrodes 17 extending from a second end of the piezoelectric layered member 13 in the longitudinal direction are defined as the B-phase (B+ and B−) external electrodes 17. Similar to the first embodiment, by applying alternating-current voltages corresponding to resonant frequencies and having synchronous phases to the A-phase and B-phase external electrodes 17, the piezoelectric layered member 13 is excited and a first-order longitudinal vibration is generated, as illustrated in FIG. 5. By applying alternating-current voltages corresponding to resonant frequencies and having opposite phases to the A-phase and B-phase external electrodes 17, the piezoelectric layered member 13 is excited and a second-order flexural vibration is generated, as illustrated in FIG. 6.

The friction-contact member 14 provided on one of the longitudinal ends of the piezoelectric layered member 13 is displaced in the longitudinal direction of the piezoelectric layered member 13 (i.e., Z direction in FIG. 9) when a first-order longitudinal vibration is generated in the piezoelectric layered member 13 and is displaced in the width direction of the piezoelectric layered member 13 (i.e., X direction in FIG. 9) when a second-order flexural vibration is generated.

Consequently, by applying the alternating-current voltages corresponding to the resonant frequencies that have a phase difference of 90° to the A-phase and B-phases external electrodes 17 of the ultrasonic vibrator 31, the first-order longitudinal vibration and the second-order flexural vibration are generated simultaneously. As a result, a vibration in a substantially elliptic motion in a clockwise or counterclockwise direction is generated at the friction-contact member 14.

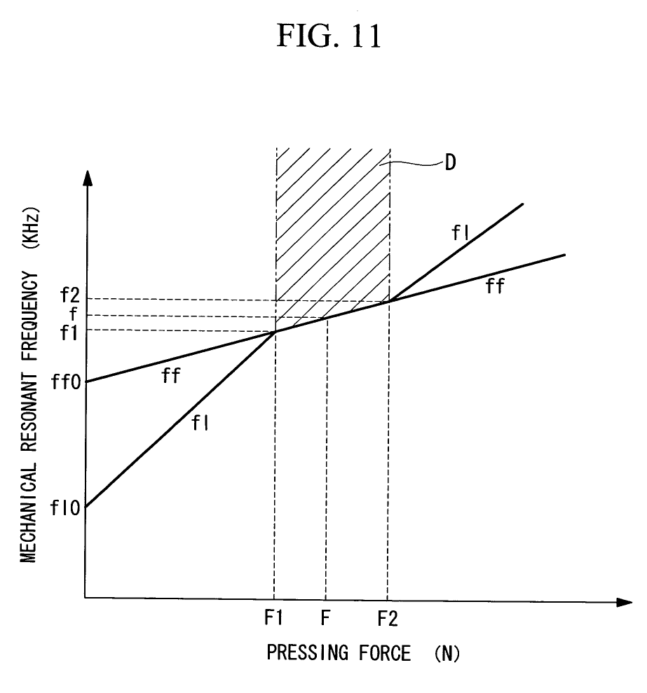

FIG. 11 is a graph illustrating how the mechanical vibration frequencies fl and ff in the different vibration modes depend on the pressing force.

As illustrated in FIG. 11, in the ultrasonic motor 30 according to this embodiment, in contrast to the ultrasonic motor 1 according to the first embodiment, when a pressing force is not applied to the pressing unit 4, the mechanical resonant frequency ff0 in the flexural vibration mode is higher than the mechanical resonant frequency fl0 in the longitudinal vibration mode. As a concrete example, the mechanical resonant frequency ff0 of the flexural vibration mode may be 92.0 khz and the mechanical resonant frequency fl0 of the longitudinal vibration mode may be 89.0 khz.

By gradually increasing the pressing force, the maximum mechanical vibration frequencies fl and ff gradually become closer and eventually match each other at a pressing force F1. Here, for example, the pressing force F1 is 800 gf (7.85 N) and the mechanical resonant frequency fl corresponding to the pressing force F1, as illustrated in FIG. 11, is 92.6 khz.

By continuously increasing the pressing force, the maximum mechanical vibration frequencies fl and ff continue to match each other until a pressing force F2. When the pressing force is greater than the pressing force F2, the mechanical resonant frequency of the longitudinal vibration mode f1 becomes higher than the mechanical resonant frequency of the flexural vibration mode ff. Here, for example, the pressing force F2 is 1.4 kgf (13.7 N) and the mechanical resonant frequency f2 corresponding to the pressing force F2, as illustrated in FIG. 11, is 93.8 khz.

In the ultrasonic motor 30 according to this embodiment, the adjustment screw 21 is adjusted so that the pressing force falls between the pressing forces F1 and F2 at which the mechanical resonant frequency fl in the longitudinal vibration mode and the mechanical resonant frequency ff in the flexural vibration mode match each other. It is more desirable to adjust the adjustment screw 21 so that the pressing force is half of the sum of the pressing forces Fl and F2 (F=(F1+F2)/2).

In the ultrasonic motor 30 according to this embodiment, having the above-described structure, the pressing force is set between the pressing forces F1 and F2 so that the mechanical resonant frequency fl in the longitudinal vibration mode and the mechanical resonant frequency ff in the flexural vibration mode, which are simultaneously generated in the ultrasonic vibrator 3, match each other. In this way, the maximum vibration amplitude in each vibration mode can be used to drive the driven body 2 and to obtain a large output force.

By adjusting the adjustment screw 21 so that the pressing force is F=(F1+F2)/2, where the mechanical vibration frequencies fl and ff match each other, the pressing force F can be maintained so that the mechanical vibration frequencies fl and ff match each other even when the actual value of the pressure F changes for some reason. Consequently, a stable large output force can be obtained.

When the ultrasonic motor 30 is driven with the mechanical vibration frequencies fl and ff matching each other in such a manner as described above, it is desirable that the frequencies of the high-frequency voltages applied to the A-phase and B-phase external electrodes 17 be in the high-frequency range (region D in FIG. 11) where frequencies are higher than the mechanical resonant frequencies. In this way, stable vibration velocity is maintained even when the frequencies changes.

In the above-described embodiments, PZT was used for the piezoelectric ceramic sheets. However, the piezoelectric ceramic sheets are not limited to PZT, and any other material may be used so long as the element has piezoelectricity.

In the above-described embodiments, silver-palladium alloy was used as the material constituting the inner electrodes. Instead, silver, nickel, platinum, or gold may be used.

Moreover, instead of bonding a sliding plate composed of zirconia ceramic on the surface of the driven body 2, -zirconia ceramic may be applied to the surface of the driven body 2 by sputtering.

What is claimed is:

1. An ultrasonic motor comprising:
an ultrasonic vibrator including an electromechanical converting element that generates a substantially elliptic vibration at an output end of the ultrasonic vibrator by simultaneously generating two different vibration modes by applying a first alternating-current voltage of a first phase and a second alternating-current voltage of a second phase to the electromechanical converting elements, the first and second alternating-current voltages having a predetermined phase difference and predetermined driving frequencies; and
a pressing unit that presses the output end of the ultrasonic vibrator against a driven body,
wherein the pressing force against the driven body on the output end of the ultrasonic vibrator by the pressing unit is set to a value which allows the mechanical resonant frequencies of the two different vibration modes to substantially match each other.

2. The ultrasonic motor according to claim 1, wherein the pressing force is set to a value substantially in the center of a predetermined range, the predetermined range corresponding to a range of pressing forces that cause the mechanical resonant frequencies in the two different vibration modes to substantially match each other.

3. The ultrasonic motor according to claim 2, wherein the driving frequencies are higher than the matched mechanical resonant frequencies in the two different vibration modes.

4. The ultrasonic motor according to claim 3,
wherein the vibration direction of one of the two vibration modes at the output end of the ultrasonic vibrator is the same as the pressing direction of the pressing unit, and
wherein the vibration direction of the other vibration mode at the output end of the ultrasonic vibrator is a direction substantially orthogonal to the pressing direction.

5. The ultrasonic motor according to claim 4, wherein the two different vibration modes are a flexural vibration mode and a longitudinal vibration mode.

6. The ultrasonic motor according to claim 1, wherein the driving frequencies are higher than the matched mechanical resonant frequencies in the two different vibration modes.

7. The ultrasonic motor according to claim 6,
wherein the vibration direction of one of the two vibration modes at the output end of the ultrasonic vibrator is the same as the pressing direction of the pressing unit, and
wherein the vibration direction of the other vibration mode at the output end of the ultrasonic vibrator is a direction substantially orthogonal to the pressing direction.

8. The ultrasonic motor according to claim 7, wherein the two different vibration modes are a flexural vibration mode and a longitudinal vibration mode.

9. The ultrasonic motor according to claim 1,
wherein the vibration direction of one of the two vibration modes at the output end of the ultrasonic vibrator is the same as the pressing direction of the pressing unit, and
wherein the vibration direction of the other vibration mode at the output end of the ultrasonic vibrator is a direction substantially orthogonal to the pressing direction.

10. The ultrasonic motor according to claim 9, wherein the two different vibration modes are a flexural vibration mode and a longitudinal vibration mode.

11. The ultrasonic motor according to claim 1, wherein the two different vibration modes are a flexural vibration mode and a longitudinal vibration mode.

12. The ultrasonic motor according to claim 1, wherein the driven body is moved linearly.

13. The ultrasonic motor according to claim 1, wherein the driven body is moved rotatively.

14. A method for operating an ultrasonic motor including an ultrasonic vibrator having an electromechanical converting element that generates a substantially elliptic vibration at an output end of the ultrasonic vibrator by simultaneously generating two different vibration modes by applying a first alternating-current voltage of a first phase and a second alternating-current voltage of a second phase to the electromechanical converting elements, the first and second alternating-current voltages having a predetermined phase difference and predetermined driving frequencies, the method comprising the step of:
setting a pressing force against the driven body on the output end of the ultrasonic vibrator to a value which allows the mechanical resonant frequencies of the two different vibration modes to substantially match each other.

15. The method for operating an ultrasonic motor according to claim 14, wherein the pressing force is set to a value substantially in the center of a predetermined range, the predetermined range corresponding to a range of pressing forces that cause the mechanical resonant frequencies in the two different vibration modes to substantially match each other.

16. The method for operating an ultrasonic motor according to claim 15, wherein the driving frequencies are higher than the matched mechanical resonant frequencies in the two different vibration modes.

17. The method for operating an ultrasonic motor according to claim 14, wherein the driving frequencies are higher than the matched mechanical resonant frequencies in the two different vibration modes.
